(19) United States
(12) Patent Application Publication
(10) Pub. No.: US 2017/0160821 A1
(43) Pub. Date: Jun. 8, 2017

(54) DISPLAY SYSTEM AND METHOD FOR OPERATING A DISPLAY SYSTEM

(71) Applicant: AUDI AG, Ingolstadt (DE)

(72) Inventor: Marcus KUEHNE, Beilngries (DE)

(73) Assignee: AUDI AG, Ingolstadt (DE)

(21) Appl. No.: 15/368,065

(22) Filed: Dec. 2, 2016

(30) Foreign Application Priority Data
Dec. 4, 2015 (DE) 10 2015 015 695.0

(51) Int. Cl. G06F 3/03; G09G 5/00; G06F 3/01

(52) U.S. Cl. CPC G06F 3/0304; G06F 3/012; G09G 5/003

(57) ABSTRACT

A change in position of electronic smart glasses is detected by a sensor device as long as the electronic smart glasses are arranged in a detection area of the sensor device. A control device drives a display device of the electronic smart glasses in dependence on the detected change in position. An adjusting device changes alignment of the sensor device in correspondence with the detected change in position of the electronic smart glasses in such a manner that the detection area of the sensor device follows the change in position of the electronic smart glasses.

### CROSS REFERENCE TO RELATED APPLICATIONS

This application claims the benefit of German Application No. 102015015695.0 filed on Dec. 4, 2015, which is incorporated by reference herein in its entirety.

### BACKGROUND

Described below is a display system and a method for operating a display system.

Display systems comprising electronic smart glasses for displaying virtual reality contents or augmented reality contents are known, per se.

For example, DE 10 2013 213 492 A1 shows a method for adapting an image displayed by electronic smart glasses. By use of a head tracking system, a wearer of the smart glasses is recorded and a head pose of the wearer of the smart glasses is extracted from the picture. Taking into consideration the extracted head pose, an augmented reality representation is displayed by the smart glasses.

U.S. Pat. No. 8,179,604 B1 shows a method for operating electronic smart glasses. The smart glasses are equipped with an infrared camera which is designed for detecting rays reflected from a marker. The marker can be, for example, a ring which a person wearing the smart glasses can stick onto one of their fingers. By use of the infrared camera, hand gestures of the person can be detected and taken into consideration in driving the smart glasses.

DE 10 2007 033 486 A1 shows a method for determining a relative arrangement of a camera with respect to an object. In addition, the object is filmed by the camera, the filmed object and virtual information being displayed together by electronic smart glasses.

To achieve as realistic as possible a representation in displaying virtual contents or augmented reality contents, respectively, usually requires as accurate as possible an acquisition of the position of the electronic smart glasses. It is particularly when the acquisition of the position of electronic smart glasses is to cover a wide range of movement of a wearer of electronic smart glasses that is usually associated with high technical expenditure and correspondingly high costs.

### SUMMARY

Described below are a display system and a method for operating a display system by which accurate acquisition of the position of electronic smart glasses is made possible with little technical expenditure.

The display system includes electronic smart glasses and a sensor device which is designed to detect a change in position of the electronic smart glasses as long as the latter are arranged in the detection area of the sensor device. Furthermore, the display system comprises a control device which is designed to drive a display device of the electronic smart glasses in dependence on the position detected. Furthermore, the display system comprises an adjusting device which is designed to change an alignment of the sensor device in correspondence with the detected change in position of the electronic smart glasses in such a manner that the detection area of the sensor device follows the change in position of the smart glasses.

In this context, the sensor device is designed to continuously detect a position of the electronic smart glasses if they are arranged in the detection area of the sensor device. On the basis of the permanent position detection of the electronic smart glasses, the sensor device can detect a change in position of the electronic smart glasses. The control device can be a part of the electronic smart glasses or also, for example, part of a computer device differing from the electronic smart glasses. Depending on the position of the electronic smart glasses just detected, the latter are driven by the control device in such a manner that contents displayed by the electronic smart glasses are adapted to the position of the electronic smart glasses just detected.

In this context, the method is based on the finding that known detection units used as sensor devices are limited to the extent that they can only detect the position of the electronic smart glasses in a particular detection area. If it is then intended to detect the position of the electronic smart glasses in a very large area, for example because a wearer of the electronic smart glasses is intended to move within a relatively large area, elaborate and cost-intensive sensor cluster structures of a plurality of sensors joined to one another are required, as a rule. The problem is solved, by the adjusting device which is designed to change a respective alignment of the sensor device in correspondence with the detected change in position of the electronic smart glasses, in such a manner that the detection area of the sensor device follows the change in position of the smart glasses. In other words, the adjusting device can always align the sensor device dynamically in such a manner that even with a change in position of the smart glasses, the latter remains within the detection area of the sensor device. For this purpose, the adjusting device can have, for example, one or also a plurality of motors in order to align, that is to say to move, the sensor device in correspondence with the detected change in position of the electronic smart glasses. In consequence, it can be ensured for very many situations that even with a change in the position of the electronic smart glasses, the latter are within the detection area of the sensor device. The detection area for position detection of the electronic smart glasses, which can be covered by the sensor device, can thus be enlarged considerably by the solution described herein without this requiring a plurality of sensor devices. As a result, true-to-life simulation surroundings of a very large area can be cost-effectively implemented, either for augmented-reality or also for virtual-reality applications.

An advantageous embodiment provides that the sensor device is supported rotatably at least around one axis of rotation and the adjusting device is designed to tilt the detection device around the axis of rotation. For example, the sensor device can be supported rotatably around its vertical axis, the adjusting device being able to tilt the sensor device around this vertical axis in dependence on the detected change in position of the electronic smart glasses. In addition, it would also be conceivable that the sensor device is supported, for example, by a ball joint, the adjusting device being designed to tilt the sensor device around all three spatial axes. In the latter case, the alignment of the sensor device can be adapted particularly flexibly to the change in position of the electronic smart glasses detected in each case so that it can be ensured for especially many cases that the electronic smart glasses remain within the detection area of the sensor device.

A further advantageous embodiment provides that the sensor device is supported to be translatorally immobile. As a result, the sensor device can be supported in a particularly stable manner since it has only at least one degree of rotational freedom but no translational degree of freedom. This contributes to being able to ensure a particularly precise detection of position of the electronic smart glasses.

In a further advantageous embodiment the sensor device has an infrared sensor which is designed to detect at least one light-emitting diode arranged at the electronic smart glasses and, based on this, to determine the position of the electronic smart glasses. By continuous determination of the position of the electronic smart glasses, the change in position of the electronic smart glasses can also be determined. In addition, the infrared sensor can also be designed to detect a plurality of light-emitting diodes arranged at the electronic smart glasses and, based thereon, to determine an alignment of the electronic smart glasses. Taking into consideration the alignment of the electronic smart glasses, the display device of the electronic smart glasses can be driven by the control device so that, for example, virtual representations or also augmented reality representations can be displayed in dependence on the detected alignment of the electronic smart glasses. This contributes to the fact that a particularly true-to-life representation can be generated by the electronic smart glasses.

According to a further advantageous embodiment, the sensor device has a single sensor for detecting the position of the electronic smart glasses. Due to the fact that the sensor device can be aligned in correspondence with the detected change in position of the electronic smart glasses, a single sensor may also be adequate, dependent on the case of application, for being able to ensure a precise position detection of the electronic smart glasses. As a result, a particularly cost-effective sensor device can be provided.

The electronic smart glasses may be augmented-reality glasses or virtual-reality glasses. Thus, either virtual environments or also augmented-reality contents can be displayed by the electronic smart glasses.

In the method for operating a display system, a change in position of electronic smart glasses arranged in a detection area of a sensor device is detected by the sensor device. A display device of the electronic smart glasses is driven in dependence on the detected change in position by a control device. In addition, the sensor device is aligned by an adjusting device in correspondence with the detected change in position of the electronic smart glasses in such a manner that the detection area of the sensor device follows the smart glasses. Advantageous embodiments of the display system should be considered as advantageous embodiments of the method with the display system performing the method.

### BRIEF DESCRIPTION OF THE DRAWINGS

Further aspects, advantages, features and details are found in the subsequent description of an exemplary embodiment, taken in conjunction with the accompanying drawings. The features and combination of features mentioned above and the features and combinations of features mentioned subsequently in the description of the figures and/or shown alone in the figures, can be used not only in the combination specified in each case but also in other combinations or by themselves without departing from the scope of the invention.

For a further description, reference is made to the exemplary embodiments in the drawings of which:

FIG. 1 is a diagrammatic perspective view of a person who has put on electronic smart glasses, a position of the electronic smart glasses being detected by a sensor device;

FIG. 2 is a perspective view of a virtual environment displayed by the electronic smart glasses, within which a virtual motor vehicle is arranged, and

FIG. 3 is a diagrammatic top view of the sensor device and the person who has put on the electronic smart glasses, a conical detection area of the sensor device being identified by hatching.

### DETAILED DESCRIPTION OF THE PREFERRED EMBODIMENT

Reference will now be made in detail to the preferred embodiments, examples of which are illustrated in the accompanying drawings, wherein identical or functionally identical elements are provided with identical reference symbols throughout.

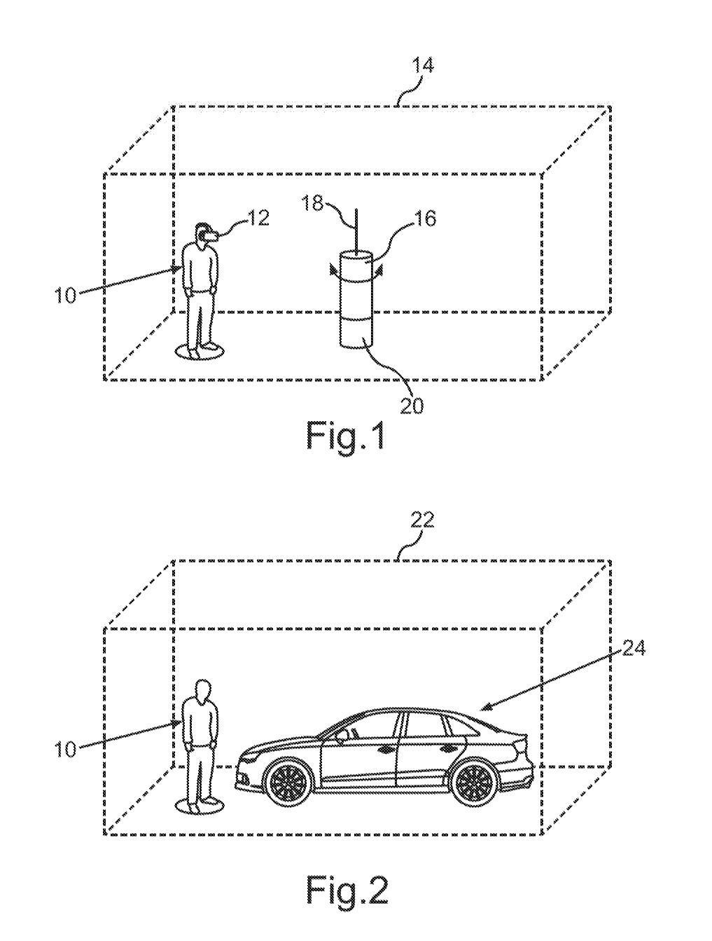

A person 10 who has put on electronic smart glasses 12 is shown in a diagrammatic perspective view in FIG. 1. The person 10 can move freely within a detection space 14 which serves as a type of simulation environment. In the detection space 14, a diagrammatically indicated sensor device 16 is also arranged which is designed to detect a position and a change in position of the electronic smart glasses 12. The sensor device 16 is supported rotatably around an axis of rotation 18, the sensor device 16 being tiltable around the axis of rotation 18 by an adjusting device 20. The electronic smart glasses 12, the sensor device 16 and the adjusting device 20 are part of a display system not designated in greater detail. The display system also comprises another control device, not shown, for driving the electronic smart glasses 12. The driving of the electronic smart glasses 12 by the control device will be discussed in greater detail in conjunction with FIG. 2.

In FIG. 2, a virtual environment 22 is shown in a perspective view, within which a virtual motor vehicle 24 is arranged. The virtual environment 22 plus the virtual motor vehicle 24 arranged therein is displayed by the electronic smart glasses 12. To indicate a virtual position of observation from which the person 10 looks at the virtual motor vehicle 24, more clearly, the person 10 is shown within the virtual environment 22. However, this is only used for illustration purposes in order to identify the virtual position of observation of the person 10 within the virtual environment 22.

As soon as a change in position of the electronic smart glasses 12 is detected in the detection space 14 by the sensor device 16, the electronic smart glasses 12 are driven by a control device, not shown in greater detail here, in such a manner that the virtual position of observation within the virtual environment 22 is adapted in correspondence with the real change in position of the person 10 in the real detection space 14. By the person 10 wandering around within the detection space 14, the person 10 can thus move virtually around the virtual motor vehicle 24. In particular, if the detection space 14 has relatively large dimensions, the problem may occur that the sensor device 16 can possibly no longer detect the change in position and the position of the electronic smart glasses 12 reliably, particularly if the person 10 together with the electronic smart glasses 12 is moving out of a detection area of the sensor device 16.

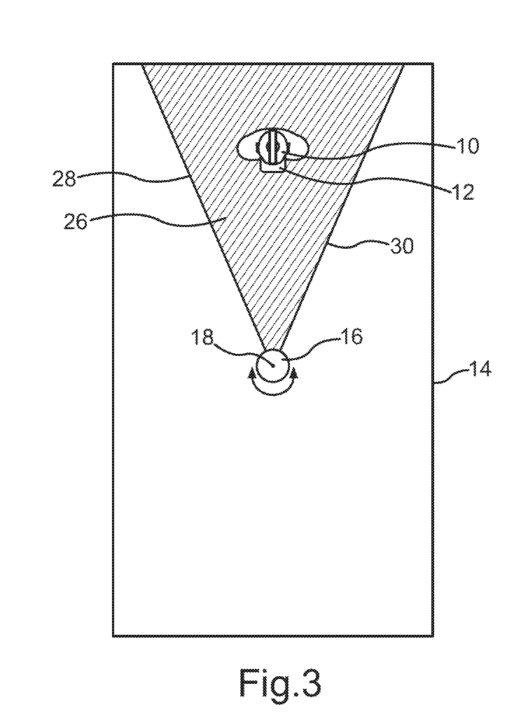

In FIG. 3, the detection space 14 is shown in a diagrammatic top view. In the present representation, the detection area 26 of the sensor device 16 is indicated diagrammatically. The detection area 26 can be configured, for example, in the form of a truncated cone. As can be seen, the person 10 together with the electronic smart glasses 12 is arranged within the detection area 26 of the sensor device 16. As long as the electronic smart glasses 12 are arranged within the detection area 26 of the sensor device 16, the position of the electronic smart glasses 12 and thus also a change in position of the electronic smart glasses 12 can be detected reliably by the sensor device 16.

In order to be able to ensure the detection of position of the electronic smart glasses 12 in a particularly large area, the sensor device 16—as already mentioned in conjunction with FIG. 1—is supported rotatably around the axis of rotation 18. The adjusting device 20, not shown here, is designed to change an alignment of the sensor device 16 in correspondence with the detected change in position in such a manner that the detection area 26 of the sensor device 16 follows the change in position of the smart glasses 12. The sensor device 16 may always tilted around the axis of rotation 18 by the adjusting device 20 in such a manner that the smart glasses 12 are substantially located centrally between two boundary areas 28, 30 of the detection area 26. If the person 10 is thus moving to the right according to the representation in FIG. 3, the sensor device 16 is correspondingly tilted around the axis of rotation 18 clockwise by the adjusting device 20 so that the electronic smart glasses 12 remain substantially centered between the two boundary areas 28, 30 of the detection area 26 in spite of the change in position. In other words, the sensor device 16 is thus always tilted in dependence on a detected change in position of the electronic smart glasses 12 in such a manner that the detection area 26 follows the change in position of the electronic smart glasses 12. The detection area 26 may be tilted by 360° around the axis of rotation 18 so that with respect to the actual size of the detection area 26 of the sensor device 16, a very large area for detecting the position of the electronic smart glasses 12 can be covered. Thus, a very accurate detection of position of the electronic smart glasses 12 can be covered with only a single sensor device 16 also in the case of a relatively large detection space 14.

The system may also include permanent or removable storage, such as magnetic and optical discs, RAM, ROM, etc. on which the process and data structures of the present invention can be stored and distributed. The processes can also be distributed via, for example, downloading over a network such as the Internet. In addition to the smart glasses, the system may output data to another display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A display system, comprising:
electronic smart glasses having a display device;
a sensor device configured to detect a change in position of the electronic smart glasses as long as the electronic smart glasses are arranged in a detection area of the sensor device;
a control device configured to drive the display device of the electronic smart glasses in dependence on the change in position detected by the sensor device; and
an adjusting device configured to change an alignment of the sensor device in correspondence with the change in position of the electronic smart glasses and thereby cause the detection area of the sensor device to follow the change in position of the electronic smart glasses.

2. A display system according to claim 1,
wherein the sensor device is supported rotatably at least around one axis of rotation, and
wherein the adjusting device is configured to tilt the sensor device around the axis of rotation.

3. A display system according to claim 2, wherein the sensor device is supported to be translatorally immobile.

4. A display system according to claim 3,
further comprising at least one light-emitting diode disposed at the electronic smart glasses, and
wherein the sensor device comprises an infrared sensor configured to detect the at least one light-emitting diode and to determine the position of the electronic smart glasses based on detection of the at least one light-emitting diode.

5. A display system according to claim 4, wherein the sensor device has a single sensor detecting the position of the electronic smart glasses.

6. A display system according to claim 5, wherein the electronic smart glasses are augmented-reality glasses.

7. A display system according to claim 5, wherein the electronic smart glasses are virtual-reality glasses.

8. A display system according to claim 1, wherein the sensor device is supported to be translatorally immobile.

9. A display system according to claim 1,
further comprising at least one light-emitting diode disposed at the electronic smart glasses, and
wherein the sensor device comprises an infrared sensor configured to detect the at least one light-emitting diode and to determine the position of the electronic smart glasses based on detection of the at least one light-emitting diode.

10. A display system according to claim 1, wherein the sensor device has a single sensor detecting the position of the electronic smart glasses.

11. A display system according to claim 1, wherein the electronic smart glasses are augmented-reality glasses.

12. A display system according to claim 1, wherein the electronic smart glasses are virtual-reality glasses.

13. A method for operating a display system, comprising:
detecting, by a sensor device, a change in position of electronic smart glasses arranged in a detection area of the sensor device;
driving, by a control device, a display device of the electronic smart glasses in dependence on the change in position detected by the sensor device; and
aligning the sensor device by an adjusting device in correspondence with the change in position of the electronic smart glasses detected by the sensor device, so that the detection area of the sensor device follows the change in position of the electronic smart glasses.

14. A method for operating a display system according to claim 13, wherein the sensor device is supported rotatably at least around one axis of rotation, and
wherein said aligning of the sensor device includes tilting the sensor device by the adjusting device around the axis of rotation.

15. A method for operating a display system according to claim 13, wherein said detecting of the change in position of the electronic smart glasses includes detecting, by an infrared sensor, at least one light-emitting diode disposed at the electronic smart glasses.
